(19) United States
(12) Patent Application Publication
(10) Pub. No.: US 2002/0198039 A1
(43) Pub. Date: Dec. 26, 2002

(54) Video slot machine that awards points for interaction of objects originally outside of the symbol matrix with objects inside of the symbol matrix

(75) Inventors: Daniel M. Marks, Brooklyn, NY (US); Anthony M. Singer, Ringwood, NJ (US); Howard M. Marks, Westport, CT (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Park Place Entertainment Corporation

(21) Appl. No.: 10/166,986

(22) Filed: Jun. 10, 2002

Related U.S. Application Data
(63) Continuation-in-part of application No. 09/998,172, filed on Dec. 3, 2001.
(60) Provisional application No. 60/250,168, filed on Dec. 1, 2000.
(60) Provisional application No. 60/324,048, filed on Sep. 24, 2001.

(51) Int. Cl. A63F 13/00

(52) U.S. Cl. 463/20

(57) ABSTRACT

A slot machine allows the interaction of objects displayed outside a symbol matrix with objects displayed inside a symbol matrix (“Interactive Symbols”) to generate new forms of awards. Interactions include “bouncing” in which logarithmic functions accounting for the objects' shapes, sizes, and velocities, control the result of two objects colliding inside of the symbol matrix, and “catching” in which the collision of two objects does not cause a “bounce” effect, but instead results in the disappearance of one object into the other object. Awards may be issued for each “bounce,” “catch” or other interaction of objects inside the symbol matrix, according to an Interactive Symbols award schedule.

### CROSS-REFERENCE TO RELATED APPLICATIONS

This application is a continuation-in-part of U.S. application Ser. No. 09/998,172 filed Dec. 3, 2001 entitled “SLOT MACHINE GAME HAVING A PLURALITY OF WAYS FOR A USER TO OBTAIN PAYOUTS BASED ON INTERACTION OF OBJECTS INSIDE AND OUTSIDE THE SYMBOL MATRIX (“INTERACTIVE SYMBOLS”)” which is hereby incorporated by reference.

This application claims the benefit of U.S. Provisional Application No. 60/250,168, filed on Dec. 1, 2000, entitled “METHOD OF PLAYING A SLOT MACHINE AND SUPPLEMENTAL PAYOFFS (“PACHINKO PAYS”),” and U.S. Provisional Application No. 60/324,048, filed on Sep. 24, 2001, entitled “SLOT MACHINE GAME HAVING A PLURALITY OF WAYS FOR A USER TO OBTAIN PAYOUTS BASED ON INTERACTION OF OBJECTS INSIDE AND OUTSIDE THE SYMBOL MATRIX (“INTERACTIVE SYMBOLS”),” both of which are hereby incorporated by reference.

### COMPACT DISC APPENDIX

This patent application includes an Appendix on one compact disc having a file named appendix.txt, created on Jun. 7, 2002, and having a size of 11,273 bytes. The compact disc is incorporated by reference into the present patent application.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of Invention

The present invention relates generally to payout methods in a mechanical, an electromechanical and/or computer-based slot machine-like games-of-chance and, more particularly, to a method, an apparatus, and a computer readable medium storing computer-executable instructions for enabling the interaction of objects displayed outside a symbol matrix with objects displayed inside a symbol matrix (“Interactive Symbols”).

2. Background Description

In a conventional slot machine, players only receive awards for winning combinations of symbols appearing within the symbol matrix:

Symbol Matrix: Slot symbols are displayed on 3 or more columns placed adjacent to each other. Each column contains at least 3 rows, with a symbol in each row. The resulting matrix of symbols (“symbol matrix”) ranges from 3 columns by 3 rows with 9 total symbols to 5 columns by 3 rows with 15 total symbols. Within the symbol matrix, positions on the slot reels may be referred to according to column, from left to right, and row, from the top to bottom (“symbol positions”). For example: symbol position 1/2 is located in column 1 (i.e., left-most column) and row 2 (i.e., middle row).

Winning Combinations: Players collect credits for predetermined winning symbol combinations that appear in specific locations (“pay lines”) on the slot reels. Winning combinations typically require that three or more of the same symbols appear adjacent to each other starting from the leftmost position of a pay line (“line pays”). For example: a player may collect a line pay if 3 Banana symbols appeared in symbol positions 1/1, 2/1, 3/1 on a pay line using symbol positions 1/1, 2/1, 3/1, 4/1, and 5/1.

Alternatively, players may also collect credits for predetermined winning combinations that appear anywhere on a pay line (“line scatter pays”) or anywhere on the slot reels (“reel scatter pays”). For example, a player may collect a line scatter pay if 3 Banana symbols appeared in symbol positions 1/1, 3/1, 5/1 on a pay line using symbol positions 1/1, 2/1, 3/1, 4/1, and 5/1; and collect a reel scatter pay if 3 Banana symbols appeared anywhere on the slot reels.

By limiting all awards to winning combinations within the symbol matrix (e.g., line pays, line scatter pays and reel scatter pays), a conventional slot machine cannot award pays, bonus features or games, and/or other events based on the interaction between objects outside and inside the symbol matrix. As a result of this limitation, conventional slot machines only offers a limited number of awards. In addition, game manufacturers and casinos suffer from building an inventory of similar games that do not distinguish themselves from the other games in the field.

It is an object of the present invention to address the limitations associated with conventional slot machines by creating new awards using the interaction of objects outside and inside the symbol matrix (“Interactive Symbols”). Thus, the Interactive Symbols concept creates a slot game with a wider variety of pay outs. For example, a “bonus ball” displayed outside of the matrix is dropped into the matrix and the following events occur:

1. The bonus ball bounces off of the various symbols in the symbol matrix. (The direction and speed of the bonus ball is controlled by the size, shape, and location of the symbols.)

2. Any symbol touching the Bonus Ball is turned into bonus credits.

3. The Bonus Ball continues to bounce around until it bounces out of the symbol matrix and off of the display screen.

4. The player then receives an award for the total value of all symbols touched by the Bonus Ball.

The Bonus Ball embodiment of the present invention is illustrated in FIGS. 8A-8E, and is described in further detail below.

The Interactive Symbols concept benefits all parties. The game manufacturer adds a unique product to their sales line, the casino attracts and retain players interested in playing an innovative slot game, and the player enjoys a new method of receiving an award.

### BRIEF SUMMARY OF THE INVENTION

The present invention includes a variety of methods of play that can be programmed on an electronic video slot machine. Each electronic video slot machine is programmed to allow interaction between the objects outside and inside the symbol matrix. In a preferred embodiment of the present invention, the player receives one Cherry object for each pay line wagered upon; each Cherry is displayed above the symbol matrix. After setting the total wager, the player spins and the game displays 15 symbols in a 3-row by 5-column symbol matrix. Three or more trigger symbols anywhere on the symbol matrix starts the Interactive Symbol concept. Once triggered, circular Cherry objects drop one-at-a-time into the symbol matrix and interact with the objects inside of symbol matrix:

Bounce Symbols: Cherries bounce off all symbols, except Catcher Symbols. The bounce effect is based on the Cherry's shape, size, and speed, and also the symbol's size and shape. In addition, the Cherry will also respond to the effect of “gravity,” an artificial downward pull which mimics the effects of gravity and acceleration.

Catcher Symbols: Cherries will not bounce off of Catcher symbols. Instead, Cherries will be “caught” inside of the symbol and award bonus points.

Objects: Cherries may also bounce off of objects outside the symbol matrix, including elements from the background. For example, Cherries may bounce off of a plate, a set of cups, or the game's credit meters.

After bouncing around, each Cherry will either land in a Catcher symbol or fall off the bottom of the screen. Each Cherry landing in the Catcher symbols generate awards; each Cherry falling off of the screen is worthless. The total value of all “caught” Cherries is awarded to the player.

Alternatively, the present invention allows for many alternative embodiments, including but not limited to the following:

1. Any type of trigger. The present invention allows for the triggering of the Interactive Symbols concept at any time. For example, Cherries may begin to drop with appearance of one or more pre-determined symbol combinations anywhere in the slot reels; with appearance of one or more pre-determined symbol combinations anywhere on a pay line; in a specific order on a pay line; at specific times during the day; in response to certain amounts of credits won; in response to input from the player and/or casino; and/or at random.

2. Any direction of entry. The present invention allows objects to enter the symbol matrix from any direction or multiple directions. For example, Cherries may be dropped from above the symbol matrix and/or thrown into the symbol matrix from the left and/or right sides. In addition, objects may enter the symbol matrix via a symbol in the symbol matrix. For example, a Cherry Tree symbol in the symbol matrix may “release” Cherries into the symbol matrix.

3. Any size or shape of objects. The present invention allows objects inside and outside the symbol matrix to take any size or shape. For example, the small, circular Cherries may be replaced by large, triangular slice of Apple Pie. Different sizes and shapes may also affect the interaction between the objects. For example, the larger Apple Pie pieces may bounce less and fall faster. In addition, the present invention may also use objects that are invisible or only visible at certain moments. For example, a Cherry may only be visible when it bounces off of another object.

4. Any number of objects. The present invention allows for any number of objects inside and/or outside the symbol matrix.

5. Any amount of interaction. The present invention allows any amount of interaction between objects inside and outside of the symbol matrix. In addition, the same object may interact with the same symbol more than once. For example, one or more Cherries may drop into the symbol matrix and bounce off the same symbol(s) an unlimited number of times.

6. Any type of interaction. The present invention allows objects to interact in one or more manners. For example, a Cherry may “bounce” off a symbol; a Cherry may be “caught” by a symbol; a Cherry may “turn” a symbol wild; a Cherry may erase a symbol; a Cherry may “change” a symbol into a different symbol or a higher paying symbol; a Cherry may “pass through” a symbol; and/or a Cherry may be “eaten” by a symbol. In addition, the interaction of two objects may also trigger bonus features and events. For example, a Cherry may bounce into a Bonus Symbol to trigger a second-screen bonus game.

7. Any type of awards. The present invention allows object interactions to result in any type of award, such as credits, free games, bonus features and events, and/or the creation of more objects.

8. Any type of resolution. The present invention allows for any type of resolution of the interactive session. For example, the session may end when all of the objects outside of the symbol matrix have been “caught” by objects inside the symbol matrix.

All of these alternative embodiments rely upon the underlying Interactive Symbols concept that allows for the interaction of objects displayed outside the symbol matrix with objects displayed inside the symbol matrix.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The Detailed Description of the Invention including the description of a preferred structure as embodying features of the invention will be best understood when read in reference to the accompanying figures wherein:

FIG. 1 shows an illustrative example of a representative display that may be encountered during a typical game;

FIG. 2 illustrates a stage of an Interactive Symbol bonus game that is triggered during a typical game in accordance with the principles of the present invention;

FIG. 3 illustrates a stage of the Dancing Tree bonus game;

FIG. 4 illustrates a stage of the Pick-A-Pie bonus game;

FIG. 5 illustrate a pay table listing payouts for winning symbol combinations encountered during a typical game;

FIGS. 6 and 7 illustrate help screens that display information concerning game operation and bonus games; and

FIGS. 8A-8G illustrate another interactive symbol bonus game in accordance with the present invention.

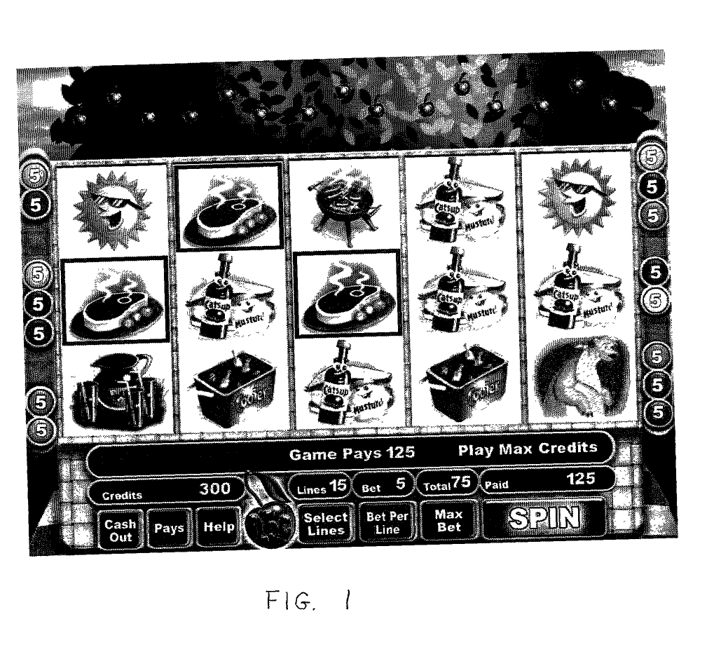

The file of this patent contains at least one drawing executed in color. Copies of this patent with color drawings will be provided by the Patent and Trademark Office upon request and payment of the necessary fee.

### DETAILED DESCRIPTION OF THE INVENTION

1. Notations and Nomenclature

The detailed descriptions which follow may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

2. Detailed Disclosure

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The preferred embodiment of the present invention includes the play of the base game and additional bonus features, including new Wild symbols and Scatter pay features, as described below: BASE GAME. To play the base game, the player establishes a pool of credits, selects pay lines, sets the wager per pay line, spins the reels, and collects credits for winning symbol combinations and bonus features.

Video Display. In a preferred embodiment of the present invention, the slot game has a five reel display using a five column by three row matrix. Alternatively, the game could utilize any number of columns and reels, such as a 3 column by 3 row matrix.

Buttons. In the preferred embodiment of the present invention, a set of buttons are mounted on the button panel and are used by the player to control the functions of the slot game. These buttons include Select Pay Lines, Bet Per Line, Max Bet, Spin Reels, Pay Table, and Help. Any or all of these control buttons may be displayed on the video display and/or buttons hard wired to the gaming device. If necessary, any number of buttons may be added to further facilitate control of the games.

Meters. In the preferred embodiment of the present invention, a set of meters are shown on the video display screen to display the salient information for the game, including Number of Pay Lines, Amount Bet Per Line, Total Bet, and Paid. The Number of Pay Lines meter is associated with the Select Pay Lines button and displays the current number of Pay Lines Selected. The Amount Bet Per Line meter is associated with the Bet Per Line button and displays the number of credits wagered per pay line. The Total Bet meter displays the cumulative value of the Number of Pay Lines and Amount Bet Per Line; and the Paid meter displays the number of credits won on the last spin. In addition, the game has a Credits meter which displays the total number credits remaining in the credit pool.

Credit Pool. In a preferred embodiment of the present invention, the player deposits coins, tokens or paper currency into the coin head slot or a paper currency bill acceptor to establish a credit pool. The amount of the pool of credits is displayed to the player on the Credits meter. The pool of credits increases and decreases according to the player's wins or losses and may be supplemented, if necessary, by the player by additional deposits of coins, tokens or paper currency.

Select Pay Lines. In a preferred embodiment of the present invention, the slot game has a plurality of pay lines upon which to wager. The pay lines wagered on by the player activate in a predetermined order. For example, the slot game may utilize nine pay lines of which the player's first wager is applied to pay line 1, the second wager is applied to pay line 2, the third wager is applied to pay line 3, and so on up until the ninth wager is applied to pay line 9. However, the games may utilize any other order of pay line activation and fewer or greater than nine pay lines may be used.

Bet Per Line. In a preferred embodiment of the present invention, the player sets the value of the wager on each pay line; the same amount is wagered on each pay line. Alternatively, the player could be allowed to make wagers of different amounts on each pay line. The total amount wagered is determined by summing the amounts wagered on each pay line.

Spin Reels. In a preferred embodiment of the present invention, the player then causes the slot machine to operate by effecting a “spin” of the reels. This can be done in any suitable manner, such as the player pressing a “spin” button on the machine's button panel and watching a video simulation of a reel slot machine.

Symbol Set. In a preferred embodiment of the present invention, each symbol is chosen from a set of twelve symbols. For each spin, the machine randomly displays three symbols from the symbol set on each reel. A common theme can be used for the symbols, and in one embodiment, the symbols are related to a Cherry Tree theme. However, any suitable symbols may be used, including the traditional fruit symbols that commonly appear on other slot machines. Furthermore, fewer or greater that twelve symbols may be used as a symbol set.

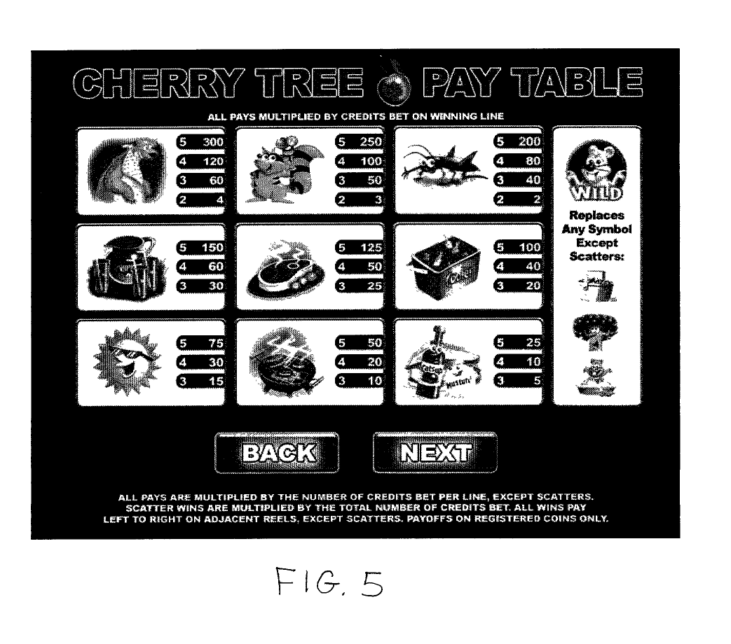

Winning Symbol Combinations. In a preferred embodiment of the present invention, the player is paid for predetermined winning combinations of symbols that appear on an active pay line. Each winning combination may involve three or more of the same symbols that appear adjacent to each other reading from the leftmost position of a pay line to the right. Each winning combination pays the amount indicated on the game's pay table times the amount wagered on that pay line. Alternatively, any desired group of symbols may be designated as winning symbol combinations and fewer or greater than three symbols could be designated as winning symbol combinations. FIG. 5 shows a sample pay table.

### BASE GAME EXAMPLE

Sam Slotsky is standing in front of a nickel-denomination version of the preferred embodiment of the present invention. Sam sees a 5-reel slot game on the video display.

Below the game on the button panel are seven buttons: Select Pay Lines, Bet Per Line, Bet Max, Spin Reels, Pay Table, Help and Cash Out. In addition, there are also four meters on the video screen display below the game: Number of Pay Lines, Amount Bet Per Line, Total Bet and Paid.

Sam presses the Pay Table button to view the pays for winning combinations. Using the numbers 1 to 12 to represent the symbol set, with 10 as the Wild symbol and 11 and 12 as the scatter symbols. The pay table for symbols 1 to 9 reads as follows (refer to the Bonus Features section below for more details on Wild symbols and Scatter Symbols):

| | | | | | |
|---|---|---|---|---|---|
| 9-9-9-9-9 | 10000 | 9-9-9-9 | 2000 | 9-9-9 | 400 |
| 8-8-8-8-8 | 7500 | 8-8-8-8 | 1500 | 8-8-8 | 300 |
| 7-7-7-7-7 | 5000 | 7-7-7-7 | 1000 | 7-7-7 | 200 |
| 6-6-6-6-6 | 2500 | 6-6-6-6 | 500 | 6-6-6 | 100 |
| 5-5-5-5-5 | 1500 | 5-5-5-5 | 300 | 5-5-5 | 60 |
| 4-4-4-4-4 | 750 | 4-4-4-4 | 150 | 4-4-4 | 30 |
| 3-3-3-3-3 | 500 | 3-3-3-3 | 100 | 3-3-3 | 20 |
| 2-2-2-2-2 | 250 | 2-2-2-2 | 50 | 2-2-2 | 10 |
| 1-1-1-1-1 | 100 | 1-1-1-1 | 20 | 1-1-1 | 4 |

*The 10 symbol is Wild and replaces any symbol except for scatters
11, 12, and 13.*
3 or more 11 symbols trigger Bouncing Cherry Bonus
3 or more 12 symbols trigger Dancing Tree Bonus:

| | |
|---|---|
| 12-12-12-12-12 anywhere on reels | 100× Total Bet |
| 12-12-12-12 anywhere on reels | 50× Total Bet |
| 12-12-12 anywhere on reels | 4× Total Bet |

3 or more 13 symbols trigger Pick-Pie Bonus with maximum win of
1000× Total Bet.

Sam deposits $20 into the bill receptor and the Credits meter counts up from 0 to 400 since the denomination for this game is five cents per credit. Sam then his chooses the wager for the game:

The game's Number of Pay Lines meter reads 1. Sam presses the Select Pay Lines button four times and the Number of Pay Lines meter counts up from 1 to 5. As Sam presses the Select Pay Lines button, the video display shows the locations of each selected pay line on the 5 column by 3 row matrix. For example, the first pay line starts in the middle row of the first column and proceeds in the straight line through the middle row of columns 2 through 5;

The game's Amount Bet Per Line meter reads 1. Sam presses the Bet Per Line button two times and the Amount Bet Per Line meter counts up from 1 to 3;

The Total Bet meter started at 1, but after Sam's adjustments it now reads 15; and

The Paid meter reads 0.

After setting his wager, Sam presses the Spin Reels button. The Credits meter counts down from 400 to 385. The slot reels spin and then come to a stop. Using the numbers 1 to 12 to represent the symbol set, with 10 as the Wild symbol and 11 and 12 as the scatter symbols, the reels of the game display the following symbols:

| | | | | |
|---|---|---|---|---|
| 3 | 1 | 6 | 7 | 5 |
| 4 | 4 | 4 | 3 | 8 |
| 6 | 6 | 1 | 9 | 7 |

(Winning symbol combination in bold.)

The game awards Sam ninety credits for a winning symbol combination of 4-4-4 on pay line 1. The award reflects the game pay table which states that 4-4-4 pays thirty credits for each credit wagered upon the pay line; or thirty credits times three credits wagered by Sam on pay line 1. The Credits meter counts up from 385 to 475 and the game Paid meter reads 90.

Content with his winnings, Sam presses the Cash Out button. The gaming device issues 475 nickels or any other form of currency, including cash, an EZ-PAY™ ticket, or electronic payment.

Bonus Features.

During play of the base games, the player may receive special pays for bonus features, such as Wild Symbols and Scatter pays.

Wild Symbols. Wild symbols replace any or all other symbols in determining winning outcomes. Alternatively, wild symbols may only replace limited subsets of the other symbols. Wild symbols, therefore, increase the possibility of a player achieving winning combinations and the pay table must reflect that the wild symbols are in use. In a preferred embodiment of the present invention, the wild symbol acts as its own symbol (e.g., three wild symbols on a pay line) while at the same time a wild symbol could also replaces every other symbol. Alternatively, any suitable replacement rules for wild symbols could be used.

Each wild symbol may also be used to affect payouts which utilize one or more wild symbols. For example, a wild symbol used in a winning combination of symbols, may double the value of the winning combination. The slot game can also be configured so that the wild symbols increase or decrease the value of any payout in any manner which results in an average value that can be utilized to control the gaming machine's overall average payouts. In the preferred embodiment of the present invention, however, the Wild symbols do not affect the value of the winning symbol combinations.

Scatter Pays. A scatter pay awards the player a predetermined payout for the appearance of a scatter symbols, or combination of scatter symbols, anywhere on a pay line (“line scatter pays”) or anywhere on the slot reels (“reel scatter pays”). Thus, if more than one scatter symbol is required to form a scatter pay, the scatter symbols in one embodiment of the invention, do not need to be located in adjacent positions.

Scatter pays award a specific number of credits and/or trigger a bonus feature, such as entertaining animations, free spins, enhanced pay table values, and/or selection of bonus object as described below in detail. The number of credits awarded may be determined by multiplying the total amount wagered by a random number within a predetermined range of numbers; or, the number of free spins awarded may be set by the number and/or arrangement of scatter symbols displayed on the reels. Alternatively, the value of the bonus feature could be determined by any other suitable calculation, such as a calculation or method where the bonus feature results in an average value that can be utilized to control the overall average payouts of the slot game.

In a preferred embodiment of the present invention, there are 3 scatter pays used to trigger bonus credit awards and bonus features. Of these scatter pays, one uses the Interactive Symbols concept to award bonus credits to the player:

Bouncing Cherries. Any three or more Basket symbols anywhere on the slot reels triggers an Interactive Symbol bonus event in which Cherries bounce off of the objects inside and outside the symbol matrix; the player receives awards for each Cherry “caught” in the Basket symbols. (Refer to the Summary Section above and the Bonus Feature Example section below for more details on the Bonucing Cherry Interactive Symbol bonus event.)

In addition to the Bouncing Cherry Interactive Symbol scatter pay, the preferred embodiment also includes 2 conventional scatter pays:

Dancing Tree. Any three or more Cherry Tree symbols anywhere on the slot reels triggers an animated bonus event in which a Cherry Tree shakes and cherries fall to the ground; the player receives awards for each Cherry that falls. See FIG. 3 for a sample screen shot of the Dancing Tree.

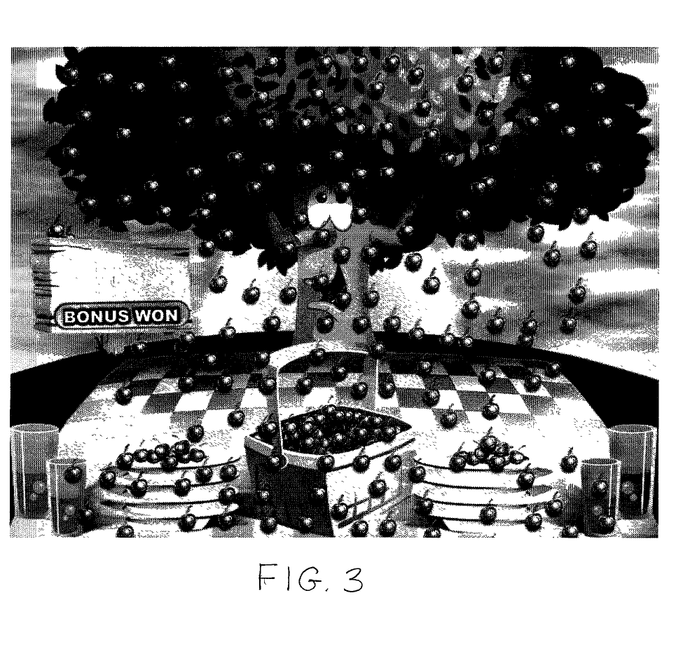

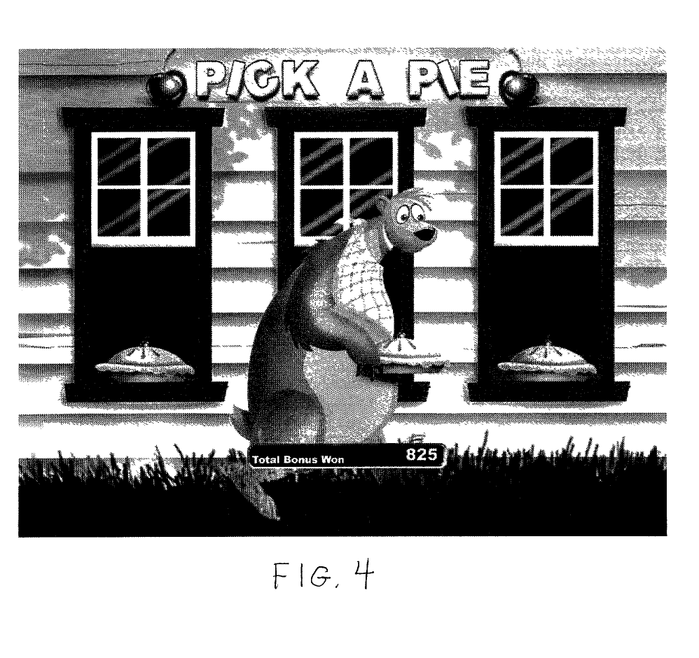

Pick-A-Pie. Any three or more Cherry Pie symbols anywhere on the slot reels triggers an animated bonus game in which the player selects one of three Cherry Pies resting on windowsills. The player continues selecting pies until the window shuts on his or her hand; the player receives awards for each pie successfully taken. See FIG. 4 for a sample screen shot of the Dancing Tree.

Both of these conventional scatter pays do not involve any interaction between objects inside and outside of the symbol matrix, but instead rely upon a fixed payout schedule to generate awards.

### BONUS FEATURE EXAMPLE

Sam Slotsky returns to the same nickel-denomination version of the preferred embodiment of the present invention, as described above in the Base Game Example section. Sam deposits $20 into the bill acceptor and the Credits meter counts up from 0 to 400. Sam then presses the Help button to view the rules of the game:

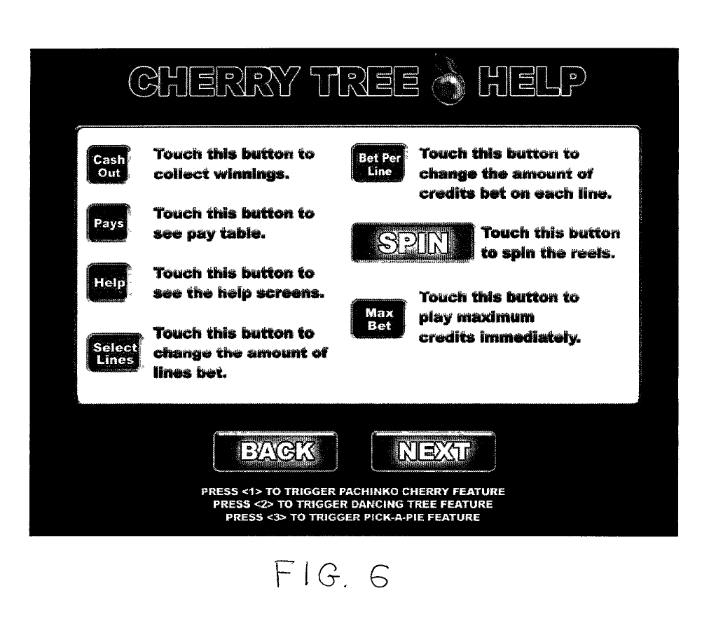

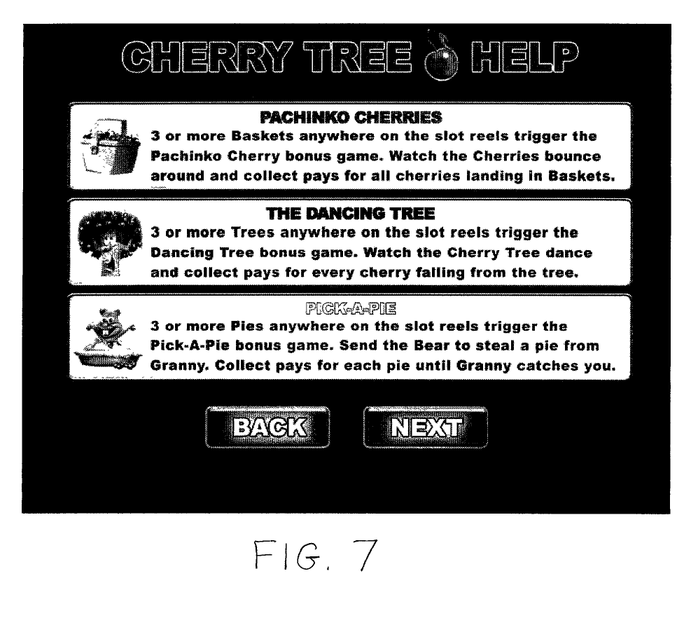

The rules of the game state that there are two bonus features: Wild symbols and Scatter pays. Wild symbols replace any symbol on the reels except for the 3 Scatter symbols. The first Scatter pay uses Interactive Symbol concept to award bonus credits and the other two scatter pays award credits according to the scatter pay table. All of the scatter pays are triggered whenever three or more of that Scatter symbol appears anywhere on the slot reels. FIGS. 6 and 7 show Help screen shots.

After reading the rules, Sam returns to the base game screen. Using the control buttons, Sam adjusts his wagers for the game; he sets the Number of Pay Lines at 9 and the Amount Bet Per Line at 2.

After setting his wagers, Sam presses the Spin Reels button. The Credits meter counts down from 400 to 382. The reels of the game spin and then come to a stop. Using the numbers 1 to 13 to represent the symbol set, with 10 as the Wild symbol and 11, 12, and 13 as the scatter symbols, the reels of the game display the following symbols:

| | | | | |
|---|---|---|---|---|
| 11 | 1 | 6 | 7 | 5 |
| 4 | 10 | 4 | 3 | 8 |
| 6 | 6 | 2 | 11 | 7 |

(Winning symbol combination in bold.)

The game awards Sam 260 credits for two winning symbol combinations of 4-10-4 on pay line 1 and 6-10-6 on pay line 5. The 10 symbol is Wild and acts as a 4 symbol to make the 4-4-4 combination and then acts as a 6 symbol to make the 6-6-6 combination. The 10 symbol does not replace as a Scatter symbols and, therefore, does not act as an 11 symbol.

The 260 credit award reflects the game's pay table which states that 4-4-4 pays thirty credits for each credit wagered upon the pay line (e.g., thirty credits times two credits wagered by Sam on pay line 1) and also states that 6-6-6 pays one hundred credits for each credit wagered upon the pay line (e.g., one hundred credits times two credits wagered by Sam on pay line 5). The Credits meter counts up from 385 to 645 and the game Paid meter reads 260.

Again, Sam presses the Spin Reels button. The Credits meter counts down from 675 to 657. The reels of the game spin and then come to a stop. Using the numbers 1 to 13 to represent the symbol set, with 10 as the Wild symbol and 11, 12, and 13 as the scatter symbols, the reels of the game display the following symbols:

| | | | | |
|---|---|---|---|---|
| 11 | 1 | 6 | 7 | 5 |
| 4 | 11 | 4 | 3 | 8 |
| 6 | 6 | 2 | 11 | 7 |

(Winning symbol combination in bold.)

With three 11 symbols on the slot reels, the game enters the Interactive Symbols bonus mode in which the following events occur and in which the following rules apply:

1. The game displays one Cherry for each pay line wagered upon.

2. Cherries are displayed above the symbol matrix.

3. All non-basket symbols turn into small, round “peg” objects.

4. All Basket symbols have multipliers displayed on the side of the basket. The value of the multiplier increases with the number of Basket symbols triggering the Interactive Symbols bonus event.

5. Cherries drop one-at-a-time into the symbol matrix.

6. Cherries bounce off of the “pegs” inside the symbol matrix, the credit meter below the symbol matrix, and the glass and plate objects on the sides of the symbol matrix.

7. Cherries bounce around and either get “caught” in a Basket symbol or fall off of the bottom of the screen. For each Cherry “caught” in a basket, the player is awarded the value of the multiplier on the side of the basket. All Cherries falling off of the screen are worthless.

8. The bonus event ends when all of the Cherries have been caught in baskets or fallen off of the screen.

9. The player receives the cumulative value of all Cherries caught in the Basket symbols. For example, a Cherry may drop in the following manner:

a. Cherry 1 is released from above the middle slot reel, just left of center.

b. The Cherry bounces off of the peg symbol at symbol position 3/1.

c. The Cherry is round with a radius of 0.34 inches, an approximate speed of 1 inch down per second, an acceleration rate of 0.8 and an angle of 170 east of north.

d. The peg symbol is round, has a radius of 0.25 inches, and an absorbency of 0.2 (absorbing 0.2 of the Cherry's energy).

e. The characteristics of the Cherry and peg result in the Cherry bouncing up, over the left and then arcing down where is bounces into the peg at symbol position 2/1.

f. The Cherry continues to bounce around off of pegs at symbol positions 3/2, 4/2, 5/2, off of a cup object outside of the symbol matrix, then back into the matrix at symbol position 5/3, and then into the Basket symbol (with a 50× multiplier) at symbol position 4/3.

For the purposes of this example, 2 Cherries land in a 50× basket, 3 Cherries land in the 100× basket and 4 Cherries fall off the bottom of the screen; a total of 400 credits. The Credits meter counts up from 657 to 1057 and the game Paid meter reads 400.

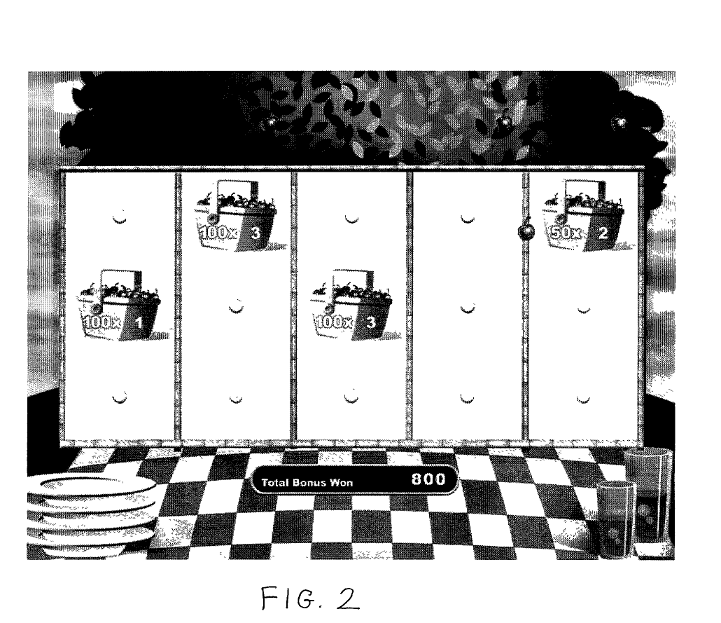

FIG. 2 shows an examples of the Interactive Symbols bonus mode described above.

Sam again presses the Spin Reels button. The Credits meter counts down from 1057 to 1039. The reels of the game spin and then come to a stop. Using the numbers 1 to 13 to represent the symbol set, with 10 as the Wild symbol and 11, 12, and 13 as the scatter symbols, the reels of the game display the following symbols:

| | | | | |
|---|---|---|---|---|
| 12 | 12 | 4 | 12 | 5 |
| 4 | 5 | 2 | 3 | 8 |
| 6 | 6 | 12 | 4 | 7 |

(Winning symbol combination in bold.)

The game awards Sam 900 credits for a Scatter symbol combination of four 12 symbols anywhere on the slot reels. The award reflects the game pay table which states that four Scatter Symbols result in an award of 50 times the total bet. The Credits meter counts up from 1039 to 1939 and the game Paid meter reads 900.

Sam again presses the Spin Reels button. The Credits meter counts down from 1939 to 1921. The reels of the game spin and then come to a stop. Using the numbers 1 to 13 to represent the symbol set, with 10 as the Wild symbol and 11, 12, and 13 as the scatter symbols, the reels of the game display the following symbols:

| | | | | |
|---|---|---|---|---|
| 13 | 13 | 3 | 2 | 5 |
| 4 | 5 | 4 | 3 | 8 |
| 6 | 6 | 13 | 4 | 7 |

(Winning symbol combination in bold.)

The game displays a second screen that shows three Cherry Pies resting on three windowsills. The game instructs the player to select one of the pie by touching a windowsill. Upon selection, the game displays a bear walking up to the selected windowsill, taking the pie, revealing an amount of credits, and granny-figure replacing the missing pie; or, the game displays the window shutting. The player continues to select pies and collect credits until the window shuts. For the purposes of this example, the bear takes a pie worth 40 credits, another worth 200 credits, and then window shuts. The Credits meter counts up from 1921 to 2,161 and the game Paid meter reads 240.

Content with his winnings, Sam presses the Cash Out button. The gaming device issues 2,161 nickels or any other form of currency, including cash, an EZ-PAY™ ticket, or electronic payment.

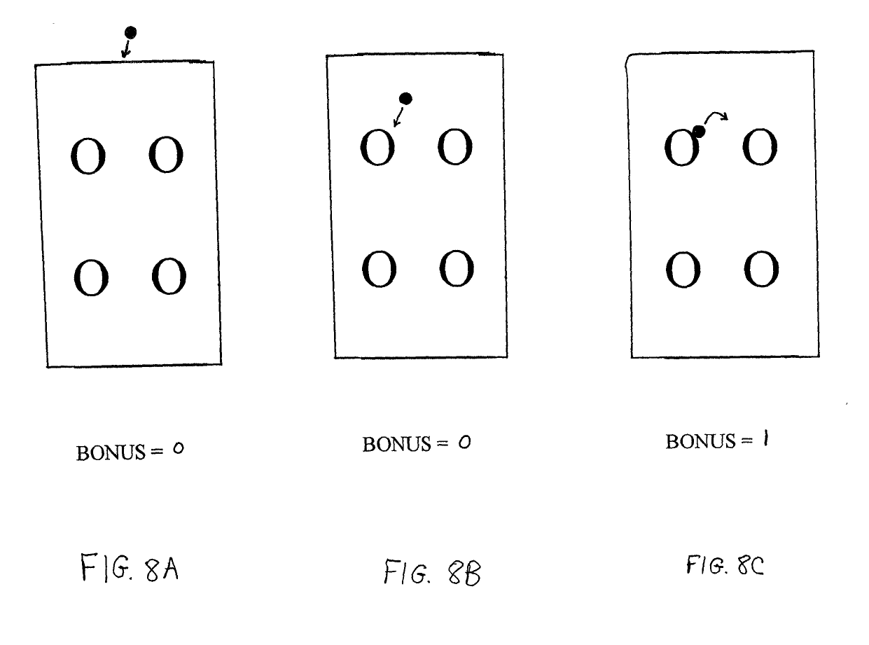

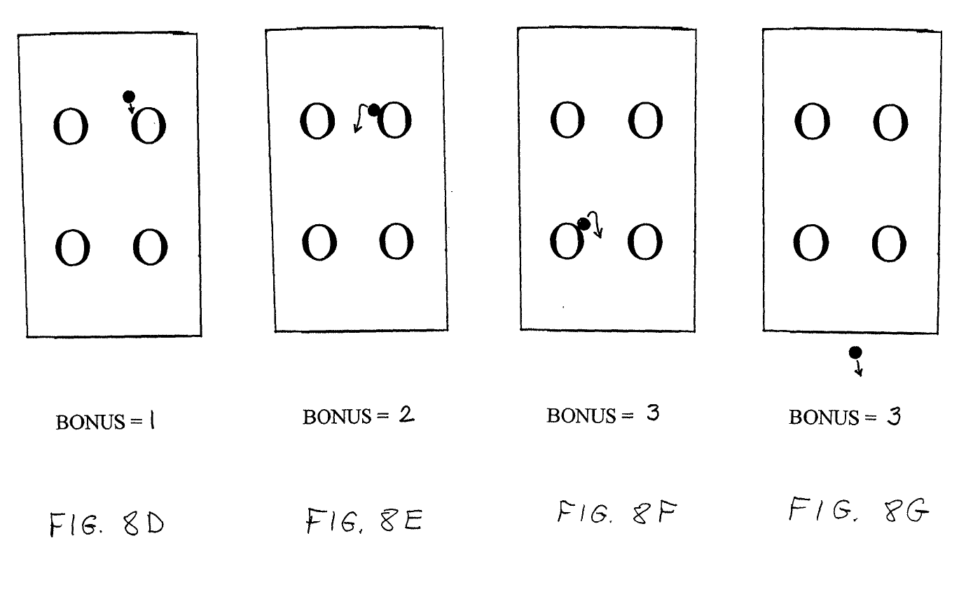

FIGS. 8A-8E illustrate the Bonus Ball embodiment of the present invention, as described above. For simplicity, the symbol matrix has only 2 rows and 2 columns, and each position in the symbol matrix is occupied by an identical circular shaped symbol. As discussed above, the symbols may be any size or shape, and there need not be a symbol in each position in the symbol matrix.

In FIG. 8A, the Bonus Ball is initially outside of the symbol matrix. In FIG. 8B, the Bonus Ball has dropped into the symbol matrix and is heading toward the symbol in position 1/1. In FIG. 8C, the Bonus Ball contacts and bounces off the 1/1 symbol and the bonus credit becomes equal to 1. In FIG. 8D, the Bonus Ball is heading towards the 1/2 symbol. In FIG. 8E, the Bonus Ball contacts and bounces off the 1/2 symbol and the bonus credit becomes equal to 2. In FIG. 8F, the Bonus Ball contacts and bounces off the 2/1 symbol and the bonus credit becomes equal to 3. In FIG. 8G, the Bonus Ball bounces out of the symbol matrix and out of the display screen (not shown).

The Appendix provides source code associated with the FIG. 2 Interactive Symbol bonus game.

The present invention may be implemented with any combination of hardware and software. If implemented as a computer-implemented apparatus, the present invention is implemented using means for performing all of the steps and functions described above.

The present invention may be implemented with any combination of hardware and software. The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

What is claimed is:

1. A method of playing a video slot machine device which has a symbol matrix, the symbol matrix including one or more objects displayed therein, the method comprising:
(a) displaying one or more objects that are initially outside of the symbol matrix;
(b) the one or more objects outside of the symbol matrix moving into the symbol matrix and at least some of the objects outside of the symbol matrix interacting with the one or more objects inside of the symbol matrix; and
(c) awarding points based upon selected interactions of the objects.

2. The method of claim 1 wherein each of objects inside the symbol matrix are stationary and at least some of the objects that are initially outside of the symbol matrix interact with at least some of the objects inside of the symbol matrix by contacting, landing in, or landing on one or more of the objects inside the symbol matrix.

3. The method of claim 2 wherein each of the one or more objects inside of the symbol matrix are located in a respective position within the symbol matrix.

4. The method of claim 1 wherein the object interaction may cause the object originally from outside of the symbol matrix to bounce off of the object inside of the symbol matrix or to be caught by the object inside of the symbol matrix.

5. The method of claim 4 wherein points are awarded for an object originally from outside of the symbol matrix that is caught by an object that is inside of the symbol matrix.

6. The method of claim 1 further comprising:
(d) playing a primary game of chance by spinning slot reels, the slot reels resulting in a randomly generated symbol matrix when the slot reels come to a rest; and
(e) determining if the primary game of chance resulted in a specific winning symbol combination, and if so, initiating a bonus game defined by steps (a)-(c).

7. The method of claim 6 wherein upon the occurrence of a specific winning symbol combination, the method further comprising:
(f) causing the non-winning symbols to become bounce objects and the winning symbol combinations to become capture objects, wherein the object interaction causes at least some of the objects originally from outside of the symbol matrix to bounce off of at least some of the bounce objects and/or to be captured by a capture object, wherein points are awarded based upon each capture.

8. The method of claim 1 wherein each of the objects inside of the symbol matrix are stationary and at least some of the objects that are initially outside of the symbol matrix interact with at least some of the objects inside of the symbol matrix by contacting and bouncing off of at least some of the objects inside of the symbol matrix, wherein points are awarded for each contact.

9. A video slot machine apparatus which has a symbol matrix, the symbol matrix including one or more objects displayed therein, the apparatus comprising:
(a) means for displaying one or more objects that are initially outside of the symbol matrix;
(b) means for causing the one or more objects outside of the symbol matrix to move into the symbol matrix and for causing at least some of the objects outside of the symbol matrix to interact with the one or more objects inside of the symbol matrix; and
(c) means for awarding points based upon the interaction of the objects.

10. The apparatus of claim 9 wherein each of objects inside the symbol matrix are stationary and at least some of the objects that are initially outside of the symbol matrix interact with at least some of the objects inside of the symbol matrix by contacting, landing in, or landing on one or more of the objects inside the symbol matrix.

11. The apparatus of claim 10 wherein each of the one or more objects inside of the symbol matrix are located in a respective position within the symbol matrix.

12. The apparatus of claim 9 wherein the object interaction may cause the object originally from outside of the symbol matrix to bounce off of the object inside of the symbol matrix or to be caught by the object inside of the symbol matrix.

13. The apparatus of claim 12 wherein points are awarded for an object originally from outside of the symbol matrix that is caught by an object that is inside of the symbol matrix.

14. The apparatus of claim 9 further comprising:
(d) means for playing a primary game of chance by spinning slot reels, the slot reels resulting in a randomly generated symbol matrix when the slot reels come to a rest; and
(e) means for determining if the primary game of chance resulted in a specific winning symbol combination, and if so, initiating a bonus game defined by steps (a)-(c).

15. The apparatus of claim 14 wherein upon the occurrence of a specific winning symbol combination, the apparatus further comprising:
(f) means for causing the non-winning symbols to become bounce objects and the winning symbol combinations to become capture objects, wherein the object interaction causes at least some of the objects originally from outside of the symbol matrix to bounce off of at least some of the bounce objects and/or to be captured by a capture object, wherein points are awarded based upon each capture.

16. The apparatus of claim 9 wherein each of the objects inside of the symbol matrix are stationary and at least some of the objects that are initially outside of the symbol matrix interact with at least some of the objects inside of the symbol matrix by contacting and bouncing off of at least some of the objects inside of the symbol matrix, wherein points are awarded for each contact.

17. An article of manufacture for playing a video slot machine device which has a symbol matrix, the symbol matrix including one or more objects displayed therein, the article of manufacture comprising a computer-readable medium holding computer-executable instructions for performing a method comprising:
(a) displaying one or more objects that are initially outside of the symbol matrix;
(b) the one or more objects outside of the symbol matrix moving into the symbol matrix and at least some of the objects outside of the symbol matrix interacting with the one or more objects inside of the symbol matrix; and
(c) awarding points based upon the interaction of the objects.

18. The article of manufacture of claim 17 wherein each of objects inside the symbol matrix are stationary and at least some of the objects that are initially outside of the symbol matrix interact with at least some of the objects inside of the symbol matrix by contacting, landing in, or landing on one or more of the objects inside the symbol matrix.

19. The article of manufacture of claim 18 wherein each of the one or more objects inside of the symbol matrix are located in a respective position within the symbol matrix.

20. The article of manufacture of claim 17 wherein the object interaction may cause the object originally from outside of the symbol matrix to bounce off of the object inside of the symbol matrix or to be caught by the object inside of the symbol matrix.

21. The article of manufacture of claim 20 wherein points are awarded for an object originally from outside of the symbol matrix that is caught by an object that is inside of the symbol matrix.

22. The article of manufacture of claim 17 wherein the computer-executable instructions perform a method further comprising:
(d) playing a primary game of chance by spinning slot reels, the slot reels resulting in a randomly generated symbol matrix when the slot reels come to a rest; and
(e) determining if the primary game of chance resulted in a specific winning symbol combination, and if so, initiating a bonus game defined by steps (a)-(c).

23. The article of manufacture of claim 22 wherein upon the occurrence of a specific winning symbol combination, the computer executable instructions perform a method further comprising:
(f) causing the non-winning symbols to become bounce objects and the winning symbol combinations to become capture objects, wherein the object interaction causes at least some of the objects originally from outside of the symbol matrix to bounce off of at least some of the bounce objects and/or to be captured by a capture object, wherein points are awarded based upon each capture.

24. The article of manufacture of claim 17 wherein each of the objects inside of the symbol matrix are stationary and at least some of the objects that are initially outside of the symbol matrix interact with at least some of the objects inside of the symbol matrix by contacting and bouncing off of at least some of the objects inside of the symbol matrix, wherein points are awarded for each contact.
